(19) United States
(12) Patent Application Publication
(10) Pub. No.: US 2010/0333043 A1
(43) Pub. Date: Dec. 30, 2010

(54) Terminating a Communication Session by Performing a Gesture on a User Interface

(75) Inventors: James Paul Faris, Santa Cruz, CA (US); Heiko Karl Sacher, Menlo Park, CA (US)

Correspondence Address: MOTOROLA INC, 600 NORTH US HIGHWAY 45, W4 - 39Q, LIBERTYVILLE, IL, 60048-5343, US

(73) Assignee: Motorola, Inc., Schaumburg, IL (US)

(21) Appl. No.: 12/491,414

(22) Filed: Jun. 25, 2009

(51) Int. Cl. G06F 3/033; G06F 3/041

(52) U.S. Cl. 715/863; 345/173

(57) ABSTRACT

There is disclosed a wireless communication device for communicating with one or more remote devices. The device comprises a touch-sensitive surface, a user interface, and a transceiver. The user interface produces an input signal in response to detecting a predetermined gesture at the touch-sensitive surface. The transceiver communicates wirelessly with a remote device and terminates communication with the remote device in response to the input signal from the user interface. The device determines that it is communicating the remote device, detects the predetermined gesture at the touch-sensitive surface, and terminates communication with the remote device in response to detecting the predetermined gesture while communicating with the remote device. The predetermined gesture includes continuous contact at the touch-sensitive surface between discrete locations of the surface.

### FIELD OF THE INVENTION

The present invention relates generally to the field of communication devices and, more particularly, to the field of wireless communication devices having a user interface capable of receiving gestures for user input.

### BACKGROUND OF THE INVENTION

A wireless communication device provides long-range communication of voice or data over a communication network of specialized base stations to other communication devices remote from the wireless communication device. One type of wireless communication device includes a touch-sensitive screen overlaying a display which renders virtual selection buttons when user input is appropriate. Although virtual selection buttons are handy, they are subject to unintentional selections of functions just like any other user interface.

Of particular interest is the unintentional selection a virtual “end call” button at the touch-sensitive screen, which results in hanging-up a call during a communication session when not desired. This problem is particularly applicable to devices having touch-sensitive screens, because a user's cheek or finger may unintentionally touch the virtual “end call” button of the touch-sensitive screen. In order to address this problem, some devices include one or more proximity sensors adjacent to the ear speaker of the device to detect whether the user's face is adjacent to the touch-sensitive screen. If so, then the device may deactivate the touch-sensitive screen and display. Multiple proximity sensors perform better than a single proximity sensor in detecting a user's face. Unfortunately, inadvertent call hang-ups may still occur if the proximity sensor or sensors do not properly detect the actual circumstances surrounding the device. Also, proximity sensors add to the total cost of the device and may not be available for lower cost devices.

The device may also include a user activated button to lock the touch-sensitive screen so that any contact to the screen will be ignored by the device. However, these screen lock functions requires the user to activate it when needed and/or deactivate it when no longer desired. When a user is ready to terminate a call, the user follows a two-step process: deactivating the screen lock function and, thereafter, selecting the virtual “end call” button to terminate the call.

### BRIEF DESCRIPTION OF THE DRAWINGS

FIG. 1 is a front, planar view of an example communication device in accordance with the present invention.

FIG. 2 is a block diagram of example components of the communication device of FIG. 1.

FIGS. 3 and 4 are screen views illustrating example embodiments in accordance with the present invention.

FIG. 5 is a flow diagram illustrating an example operation in accordance with the present invention.

### DETAILED DESCRIPTION OF THE EMBODIMENTS

There is disclosed an efficient and cost-effective communication device, and a method thereof, that minimizes the chances of inadvertently terminating a communication session or call. The device and method involves a simple user action that maximizes reliability and does not require any type of proximity sensor. In particular, the communication device allows a user to provide a predetermined gesture, such as sliding one or more digits of the user's hand across a surface. The user may avoid inadvertently disconnecting a communication session or call that may be caused by accidentally contacting a call termination button.

One aspect of the present invention is a wireless communication device for communicating with one or more remote devices. The device comprises a touch-sensitive surface, a user interface and a transceiver. The user interface produces an input signal in response to detecting a predetermined gesture at the touch-sensitive surface. The predetermined gesture is more than mere contact with the touch-sensitive surface and includes continuous contact at the touch-sensitive surface from a first discrete location to a second discrete location remote from the first discrete location. The transceiver communicates wirelessly with a remote device and terminates the communication with the remote device in response to the input signal from the user interface.

Another aspect of the present invention is a method of a wireless communication device having a touch-sensitive surface. The wireless communication device determines that it is communicating wirelessly with a remote device. The device then detects a predetermined gesture at the touch-sensitive surface. Thereafter, the device terminates the communication between the wireless communication device and the remote device in response to detecting the predetermined gesture while the wireless communication device is communicating with the remote device.

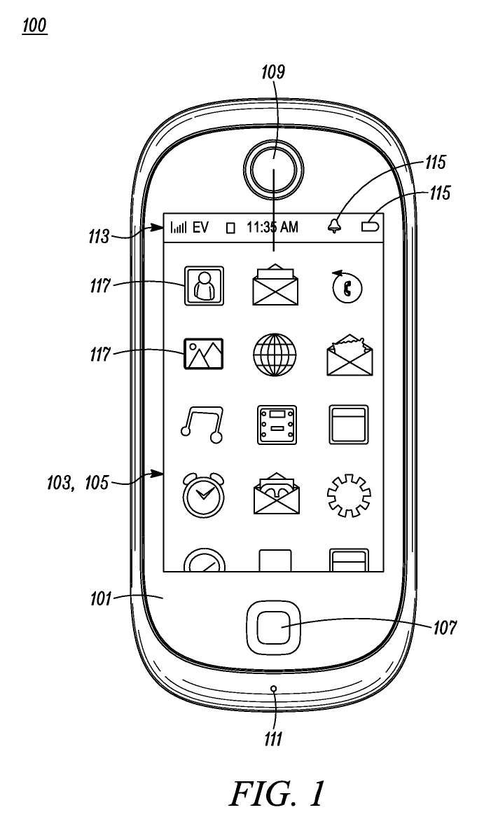

Referring to FIG. 1, there is illustrated a perspective view of an example communication device in accordance with the present invention. The device may be any type of communication device 100 having the capability of conducting a communication session or call with a remote device. Examples of the communication device 100 include, but are not limited to, cellular-based mobile phones, WLAN-based mobile phones, personal digital assistants, personal navigation device, touch screen input device, pen-based input devices, portable video and/or audio players, and the like.

For one embodiment, the communication device 100 has a housing comprising a housing surface 101 which includes a visible display 103 and a user interface. For example, the user interface may be the touch-sensitive surface 105 that overlays the display 103. With the touch-sensitive surface 105 overlaying the display 103, the display may provide feedback associated with the predetermined gesture as the predetermined gesture is detected. For another embodiment, the user interface of the communication device 100 may include a touch-sensitive surface 105 supported by the housing and does not overlay any type of display. For yet another embodiment, the user interface of the communication device 100 may include one or more input keys 107 used in conjunction with the touch-sensitive surface 105. Examples of the input key or keys 107 include, but are not limited to, keys of an alpha or numeric keypad, a physical keys, touch-sensitive surfaces, multipoint directional keys. The communication device 100 may also comprise apertures 109, 111 for audio output and input at the surface. It is to be understood that the communication device 100 may include a variety of different combination of displays and interfaces, so long as the device comprises a touch-sensitive surface 105 capable of receiving a gesture as described herein.

The display 103 of the communication device 100 may be partitioned into a plurality of regions for providing specific functionality in each region. For example, the display 103 may provide a device toolbar 113 for indicating device status and/or general information 115. For another region, for example, the display 103 may provide one or more applications, represented by icons 117, for performing a particular function of the communication device 100, such as initiating or receiving a communication session or call.

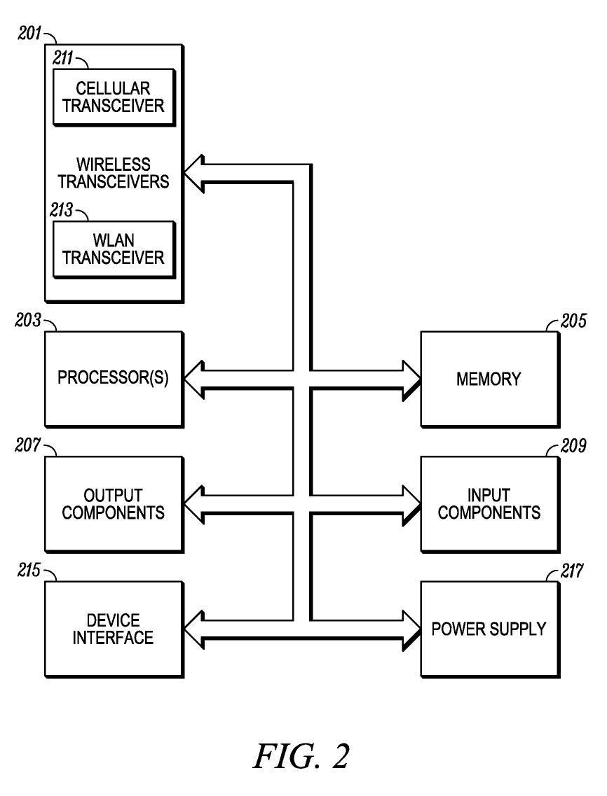

Referring to FIG. 2, there is shown a block diagram representing example components that may be used for an embodiment in accordance with the present invention. The example embodiment includes one or more wireless transceivers 201, one or more processors 203, one or more memories 205, one or more output components 207, and one or more input components 209. Each embodiment may include a user interface that comprises one or more output components 207 and one or more input components 209. Each wireless transceiver 201 may utilize wireless technology for communication, such as, but are not limited to, cellular-based communications such as analog communications (using AMPS), digital communications (using CDMA, TDMA, GSM, iDEN, GPRS, or EDGE), and next generation communications (using UMTS, WCDMA, LTE, LTE-A or IEEE 802.16) and their variants, as represented by cellular transceiver 311. Each wireless transceiver 201 may also utilize wireless technology for communication, such as, but are not limited to, peer-to-peer or ad hoc communications such as HomeRF, Bluetooth and IEEE 802.11 (a, b, g or n); and other forms of wireless communication such as infrared technology, as represented by WLAN transceiver 213. Also, each transceiver 201 may be a receiver, a transmitter or both.

The processor 203 may generate commands based on information received from one or more input components 209. The processor 203 may process the received information alone or in combination with other data, such as the information stored in the memory 205. Thus, the memory 205 of the internal components 200 may be used by the processor 203 to store and retrieve data. The data that may be stored by the memory 205 include, but is not limited to, operating systems, applications, and data. Each operating system includes executable code that controls basic functions of the portable electronic device, such as interaction among the components of the internal components 200, communication with external devices via each transceiver 201 and/or the device interface (see below), and storage and retrieval of applications and data to and from the memory 205. Each application includes executable code utilizes an operating system to provide more specific functionality for the portable electronic device. Data is non-executable code or information that may be referenced and/or manipulated by an operating system or application for performing functions of the portable electronic device. The memory 205 may store a plurality of gestures including the predetermined gesture. Thus, the processor 203 may retrieve information the memory 205 relating to one or more predetermined gestures, and correlate a gesture received at the user interface with one of the stored predetermined gesture.

The input components 209 of the internal components 200 include a touch-sensitive surface. The input components 209, such as a user interface, may produce an input signal in response to detecting a predetermined gesture at the touch-sensitive surface. As a result, a transceiver 201 may terminate communication with the remote device in response to the input signal from the user interface. In addition, the input components 209 may include one or more additional components, such as a video input component such as an optical sensor (for example, a camera), an audio input component such as a microphone, and a mechanical input component such as button or key selection sensors, touch pad sensor, another touch-sensitive sensor, capacitive sensor, motion sensor, and switch. Likewise, the output components 207 of the internal components 200 may include one or more video, audio and/or mechanical outputs. For example, the output components 207 may include a video output component such as a cathode ray tube, liquid crystal display, plasma display, incandescent light, fluorescent light, front or rear projection display, and light emitting diode indicator. Other examples of output components 207 include an audio output component such as a speaker, alarm and/or buzzer, and/or a mechanical output component such as vibrating or motion-based mechanisms.

The internal components 200 may further include a device interface 215 to provide a direct connection to auxiliary components or accessories for additional or enhanced functionality. In addition, the internal components 200 preferably include a power source 217, such as a portable battery, for providing power to the other internal components and allow portability of the communication device 100.

It is to be understood that FIG. 2 is provided for illustrative purposes only and for illustrating components of a portable electronic device in accordance with the present invention, and is not intended to be a complete schematic diagram of the various components required for a portable electronic device. Therefore, a portable electronic device may include various other components not shown in FIG. 2, or may include a combination of two or more components or a division of a particular component into two or more separate components, and still be within the scope of the present invention.

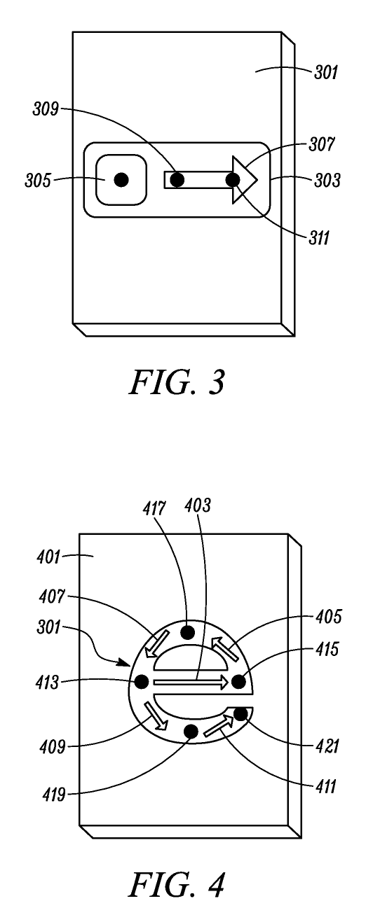

Referring to FIGS. 3 and 4, there are shown screen views illustrating example embodiments in accordance with the present invention. To provide a clear description of these embodiments, other elements or components of the communication device are not shown in these figures. It is to be understood that, even though these other elements or components are not shown, the embodiments illustrated by FIGS. 3 and 4 may incorporate them without departing from the spirit and scope of the present invention. Examples of elements or components not shown in FIGS. 3 and 4 include, but are not limited, the supporting structure and associated components of the communication device, such as the components of FIGS. 1 and 2, as well as additional elements that may be shown in the screen views, such as the device toolbar 113 and application icons 117.

Referring specifically to FIG. 3, there is shown a screen view 301 that includes a user interface, i.e., a touch-sensitive surface 105, overlaying at least part of a display 103, in which the user interface detects a predetermined gesture. For the embodiment shown in FIG. 3, The user interface includes a gesture region 303, a gesture follower 303, and a gesture indicator 307. The gesture region 303 represents the region of the touch-sensitive surface 105 in which gestures are expected and gesture recognition is operable. The gesture follower 305 represents an icon that moves in sync with a user's input as the user provides a gesture within the gesture region 303. For another embodiment, the gesture region 303 may also serve as the bounding guide for movement of the gesture follower 305 as the user provides a gesture at the user interface. The gesture indicator 307 provides a directional indicator of the movement of the gesture follower 305 if the associated gesture is desired.

The predetermined gesture includes continuous contact at the user interface, such as touch-sensitive surface 105, from a first discrete location to a second discrete location remote from the first discrete location. For example, as shown in FIG. 3, the gesture follower 305 be positioned at its starting location in the gesture region 303 before contact by the user to the gesture region is detected by the user interface. A first location 309 and a second location 311, shown in FIG. 3, are considered to be discrete locations relative to the starting location of the gesture follower 305, because these locations do not overlap the starting location and are remote from the starting location. From this starting location, the gesture may comprise sliding contact against the user interface in a direction away from the starting location. Continuous sliding contact from the starting location to either of these locations 309, 311 may correlate with a predetermined gesture among a plurality of gestures stored in memory 205 and, thus, trigger a function associated with the predetermined gesture.

The particular gestured illustrated by FIG. 3 is a linear sliding gesture in which continuous contact at the user interface between the first and second discrete locations leaves a linear trail. For one embodiment, after a communication session or call is connected with a remote device, the transmission or reception screen of the device may be replaced by a gesture region 303 (visible or not) that has a horizontal configuration to allow the user to disconnect the active call. For other embodiments, the gesture region 303 may have other configurations, such as a vertical configuration or diagonal configuration.

Referring to FIG. 4, there is shown a screen view illustrating another example embodiment in accordance with the present invention. In contrast to the embodiments illustrated by FIG. 3, the embodiments illustrated by FIG. 4 are non-linear sliding gestures in which continuous contact at the user interface between the first and second discrete locations leaves a non-linear trail. For other embodiments, the gesture may take the form of an arcuate configuration, an angular configuration, or a combination of these configurations. For example, as shown in FIG. 4, the gesture may be a linear form 403 followed by an arcuate form 405, 407, 409, 411 in which the entire gesture is one continuous contact against the user interface. For the embodiment shown in FIG. 4, the entire gesture may take the form of the letter “e” to trigger the function for “end call”.

Also, for the embodiment shown in FIG. 4, the starting location of the gesture is represented by a third location 413, and fourth, fifth, sixth and seventh locations 415, 417, 419, 421 are considered to be discrete locations relative to the starting location of the gesture. Continuous sliding contact from the starting location 413 to any of these other locations 415, 417, 419, 421 may correlate with a predetermined gesture among a plurality of gestures stored in memory 205 and, thus, trigger a function associated with the predetermined gesture.

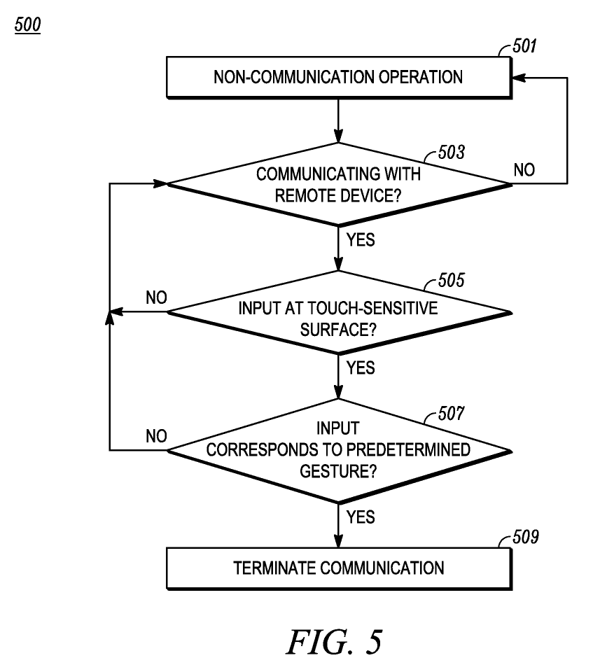

Referring to FIG. 5, a flow diagram illustrating an example operation 500 in accordance with the present invention. Starting at step 501, the communication device 100 performs some type of operation, default or otherwise, before a communication session or call is initiated. Before this initial step, the device 100 may store a plurality of gestures including the predetermined gesture in memory 205. The communication device 100 then determines whether the device, namely one or more of its transceivers 201, is communicating wirelessly with a remote device at step 503. The device 100 continues to perform its existing operation(s) until wireless communication with a remote device is determined. If the device 100 determines that it is communicating wirelessly with a remote device, then the device tries to detect an input at the user interface, such as a touch-sensitive surface 105, at step 505. If an input is detected at the user interface, then the device determines whether the detected input corresponds to a predetermined gesture stored in memory 205 at step 507. As described above, the predetermined gesture includes continuous contact at the user interface from a first discrete location to a second discrete location remote from the first discrete location. If the device finds a corresponding predetermined gesture, then the device is considered to have detected a predetermined gesture at the user interface. As a result, the device 100 terminates the communication between the wireless communication device and the remote device, at step 509, in response to detecting the predetermined gesture while the wireless communication device is communicating with the remote device. The communication device 100 may provide feedback associated with the predetermined gesture at an output component 207, such as display 103, as the predetermined gestured is detected at an input component 209, such as the touch-sensitive surface 105.

While the preferred embodiments of the invention have been illustrated and described, it is to be understood that the invention is not so limited. Numerous modifications, changes, variations, substitutions and equivalents will occur to those skilled in the art without departing from the spirit and scope of the present invention as defined by the appended claims.

What is claimed is:

1. A wireless communication device for communicating with one or more remote devices comprising:
a touch-sensitive surface;
a user interface for producing an input signal in response to detecting a predetermined gesture at the touch-sensitive surface; and
a transceiver for wireless communication with a remote device, the transceiver terminating the communication with the remote device in response to the input signal from the user interface.

2. The wireless communication device of claim 1, wherein the predetermined gesture includes continuous contact at the touch-sensitive surface from a first discrete location to a second discrete location remote from the first discrete location.

3. The wireless communication device of claim 1, further comprising a memory for storing a plurality of gestures including the predetermined gesture.

4. The wireless communication device of claim 1, wherein the touch-sensitive surface overlays a display which provides feedback associated with the predetermined gesture as the predetermined gesture is detected.

5. The wireless communication device of claim 1, further comprising a housing supporting the touch-sensitive surface.

6. A method of a wireless communication device having a touch-sensitive surface, the method comprising:
determining that the wireless communication device is communicating wirelessly with a remote device;
detecting a predetermined gesture at the touch-sensitive surface; and
terminating the communication between the wireless communication device and the remote device in response to detecting the predetermined gesture while the wireless communication device is communicating with the remote device.

7. The method of claim 6, wherein the predetermined gesture includes continuous contact at the touch-sensitive surface from a first discrete location to a second discrete location remote from the first discrete location.

8. The method of claim 6, further comprising storing a plurality of gestures including the predetermined gesture.

9. The method of claim 6, further comprising providing feedback associated with the predetermined gesture as the predetermined gestured is detected.
